(19) United States
(12) Patent Application Publication
(10) Pub. No.: US 2011/0096355 A1
(43) Pub. Date: Apr. 28, 2011

(54) PRINTING IMAGE METADATA

(75) Inventor: Hung Khei Huang, Irvine, CA (US)

(73) Assignee: CANON KABUSHIKI KAISHA, Tokyo (JP)

(21) Appl. No.: 12/605,227

(22) Filed: Oct. 23, 2009

(51) Int. Cl. G06F 3/12

(52) U.S. Cl. 358/1.15

(57) ABSTRACT

A method for printing image including selecting data to be printed, wherein the data includes image data, setting printing preferences associated with a print job to print the data, submitting the print job, receiving the print job, detecting whether metadata associated with the data to be printed exists in the print job, determining whether any detected metadata is to be printed along with the data to be printed, creating a file to be printed, wherein the file includes the data to be printed and metadata determined to be printed, and printing the file.

### BACKGROUND OF THE INVENTION

1. Field of the Invention

The present invention relates generally to printer drivers and more particularly to printer drivers accessing image metadata when printing images.

2. Description of the Related Art

With the increase in popularity over the past several years of digital photography and printing digital images, there has been a call by consumers for the ability to modify digital photos so the digital photos contain identifying information when printed.

In response to this demand, numerous digital photo editing software applications have provided a feature allowing a user to add captions, dates, etc. to digital photos prior to the user printing the digital photos. The information being added to the digital photo is typically obtained from the digital photo's metadata.

Once the digital photo has been modified to the user's liking, the modified digital photo is then saved as an application dependent file. In another case, the modified digital photo can be saved where the metadata has been embedded into the digital photo itself, thus permanently altering the original digital photo.

With the above-described approach of modifying a digital photo, a user is bound to a particular editing software application if the user wishes to use the specific features provided by that editing software application. For example, user A adds a date and caption to a digital photo using editing software application A and then provides the edited digital photo to user B. In this scenario, in order for user B to print the edited digital photo, user B would need to have the same exact editing software application that user A used to edit the digital photo.

In another example, user A adds a date and caption to a digital photo using editing software application A and then provides the edited digital photo to user B. If user B wishes to further modify the edited digital photo, e.g., move a previously added date from one location in the digital photo to a different location, user B would need to have the same exact editing software application that user A used to add the date to the digital photo.

In light of the above, what is needed is a way to add information to a digital photo for printing in an application independent manner.

### SUMMARY OF THE INVENTION

To solve the aforementioned issues, the present invention provides a method for adding information to a digital photo for printing in an application independent manner.

According to an aspect of the present invention, a method for printing an image includes selecting data to be printed, wherein the data includes image data, setting printing preferences associated with a print job to print the data, submitting the print job, receiving the print job, detecting whether metadata associated with the data to be printed exists in the print job, determining whether any detected metadata is to be printed along with the data to be printed, creating a file to be printed, wherein the file includes the data to be printed and metadata determined to be printed, and printing the file.

Further aspects and features of the present invention will become apparent from the following description of exemplary embodiments (with reference to the attached drawings).

### BRIEF DESCRIPTION OF THE DRAWINGS

FIG. 1 is a block diagram illustrating a printing system of an exemplary embodiment of the present invention.

FIG. 2 is a block diagram illustrating an example of the internal architecture of a computer utilizing the printer driver of the present invention.

FIG. 3 is flowchart of a printing method according to an exemplary embodiment of the present invention

FIG. 4 is an example of a user interface according to an exemplary embodiment of the present invention.

FIGS. 5A and 5B are examples of a print ticket according to an exemplary embodiment of the present invention

### DETAILED DESCRIPTION OF EXEMPLARY EMBODIMENTS

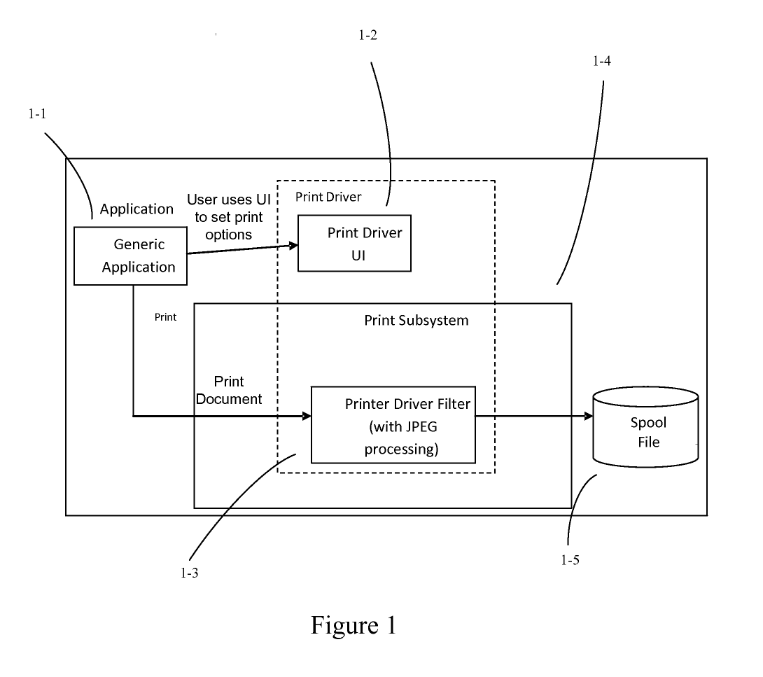

FIG. 1 is a block diagram illustrating a printing system of an exemplary embodiment of the present invention. More specifically, a user initially launches a generic application 1-1 on a host computer, such as a word processor, photo editing application, etc. When the user is ready to print a document, etc. from the generic application 1-1, the user typically selects the print option provided by the generic application 1-1.

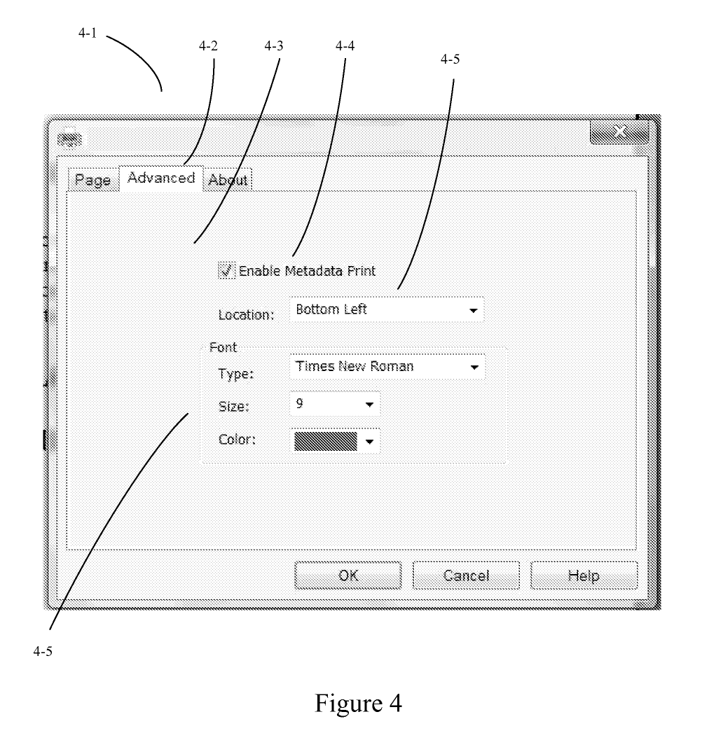

The print option of the generic application 1-1 typically provides the user with several options. One option is to set the print parameters, e.g., paper type, page size, double-sided, etc. associated with the particular print job. If the user chooses to modify the print parameters, the changes are made via the print driver UI 1-2. The print driver of the present invention includes a feature to print metadata associated with the print job as described below with respect to FIG. 4.

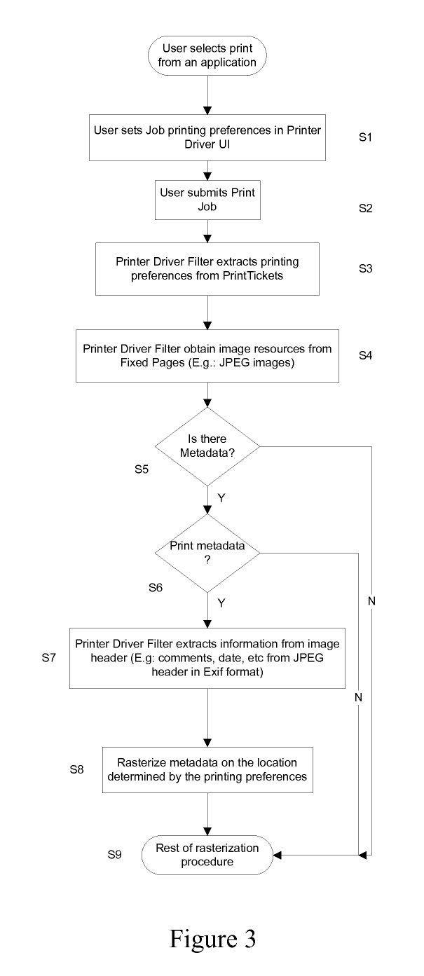

If the user chooses not to modify any of the print parameters, then the user initiates the print process. The print process according to an exemplary embodiment of the present invention includes sending the print data to the printer driver filter 1-3 of the present invention. The processing associated with the printer driver filter 1-3 is described below with respect to FIG. 3. The printer driver filter 1-3 is part of the print subsystem associated with the particular operating system of the host computer. Upon completion of the processing by the printer driver filter 1-3, a spool file 1-5 is generated which is sent to a selected printer (not shown) for printing.

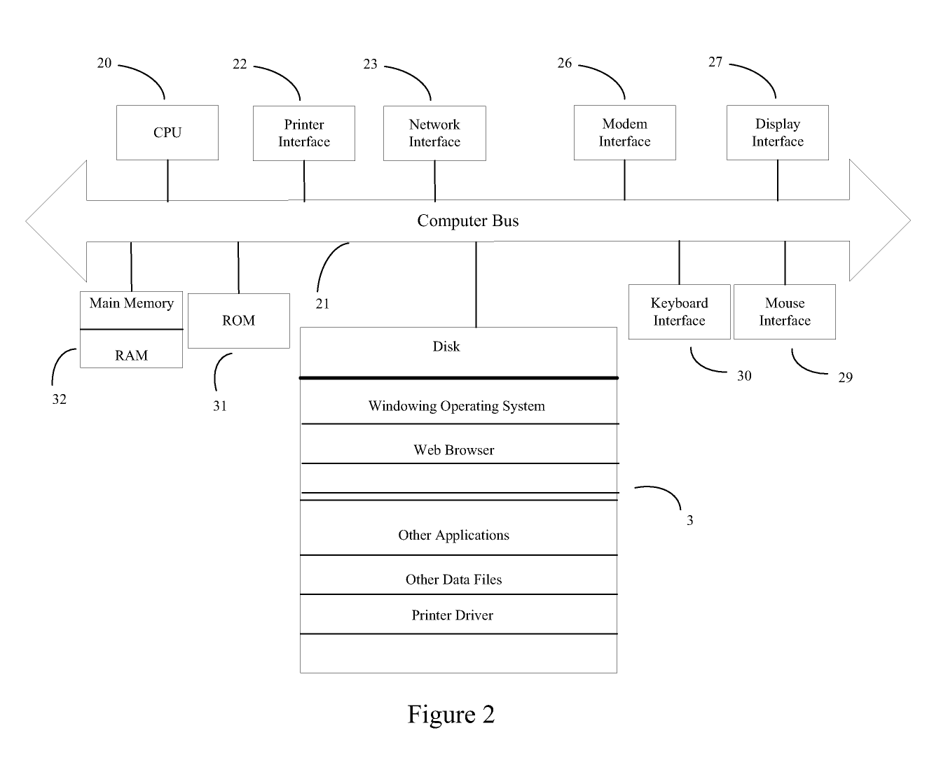

FIG. 2 is a block diagram of the internal architecture of a computer utilizing the printer driver of the present invention. Shown in FIG. 2 is CPU 20, which can be any type of microprocessor, which interfaces to computer bus 21. Also interfacing with computer bus 21 are printer interface 22, allowing the computer to communicate with a local printer (not shown), network interface 23 enabling communication between the computer and a network, modem interface 26 enabling communication between the computer and its internal modem (not shown), display interface 27 for interfacing with a display monitor (not shown), keyboard interface 30 for interfacing with a keyboard (not shown), and mouse interface 29 for interfacing with a mouse (not shown).

Read only memory (ROM) 31 stores invariant computer-executable process steps for basic system functions such as basic I/O, start-up, or reception of keystrokes from a keyboard. Main random access memory (RAM) 32 provides CPU 20 with memory storage that can be accessed quickly.

Also shown in FIG. 2 is disk 3, which includes an operating system, web browser, other applications which may include word processing, spreadsheet, and graphics, and data files. Disk 3 further includes the printer driver of the present invention.

FIG. 3 is a flowchart describing an exemplary embodiment of a system according to the present invention. Briefly, the steps include submission of a print job, detection of whether metadata exists in the print data of the print job, determining whether any of the metadata is to be printed, and printing the data to be printed and the metadata.

In more detail, in step S1, job printing preferences for a particular print job are set via a printer driver user interface (UI) of a printer selected to print out the print job. FIG. 4 illustrates an exemplary example of a printer driver UI 4-1 of the present invention.

User interface 4-1 includes a number of tabs, including Advanced tab 4-2. Upon selection of Advanced tab 4-2, UI 4-3 is displayed. User interface 4-3 includes Enable Metadata Print 4-4, Location 4-5, and Font 4-5.

If a user wishes to print metadata present in the selected print job, then the checkbox of Enable Metadata Print 4-4 is selected as illustrated in FIG. 4. Location 4-5 is used to select the location on the print page where the metadata is to be rasterized and printed. Font 4-5 allows the user to select font information, such as type, size, color, etc., with which the metadata is to be printed.

Next, in step S2, the print job is submitted to the selected printer. The step of submitting a print job to a selected printer is known in the art and thus, a detailed description thereof is omitted herein.

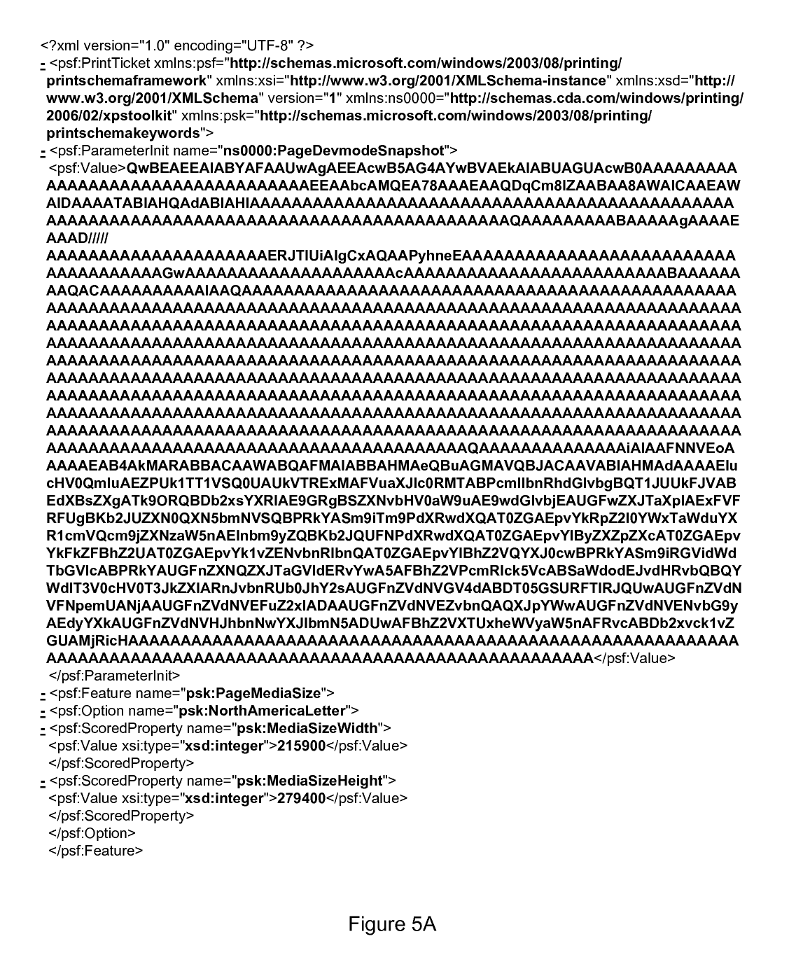

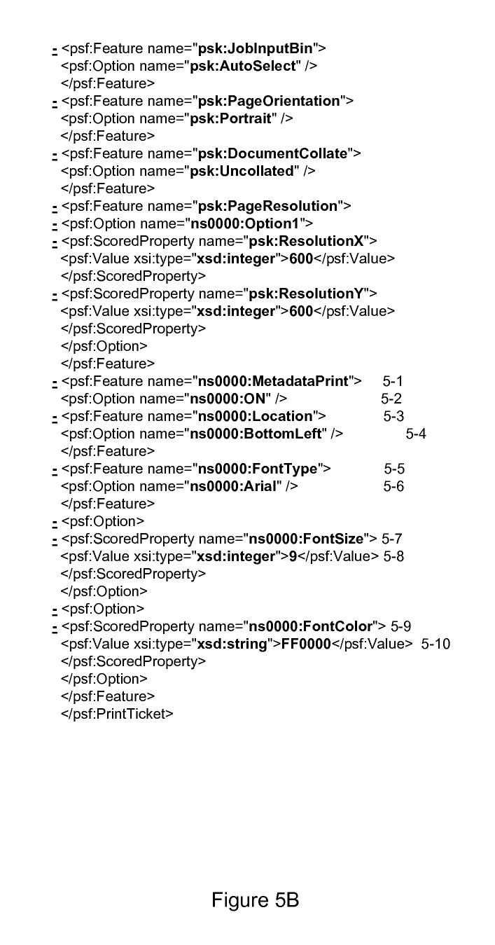

In step S3, the printer driver filter, upon receipt of the submitted print job, extracts the printing preferences from the PrintTicket(s) associated with the print job. FIGS. 5A ad 5B illustrate an example of a PrintTicket according to an exemplary embodiment of the present invention. Turning to FIG. 5B, lines 5-1 through 5-10 of the PrintTicket include the instructions regarding printing of the metadata as set via UI 4-3.

In step S4, the printer driver filter obtains image resources, e.g., JPEG images, from the pages of the print job. The method of obtaining the image resources from the pages of a print job is known in the art, and thus a detailed description is omitted herein.

Next, in step S5, a check is made to determine whether the print job includes metadata. For example, a page of the print job is initially examined to determine if any images are present on the page. This can be accomplished by analyzing various elements, e.g., text, image, etc., present on the page. If an image is determined to be present on the page, then the header of the image is examined to determine if a metadata field is present in the header.

If it is determined that the print job includes metadata, flow proceeds to step S6, where a check is made whether the metadata is to be printed. This determination is based on the setting in the Enable Metadata Print 4-4 checkbox of FIG. 4. If it is determined that the print data is to be printed, i.e., the Enable Metadata Print 404 checkbox is checked, flow proceeds to step S7.

In step S7, the printer driver filter extracts information from the image header. For example, data such as user comments, data, time, date, etc. is extracted from the image, e.g., JPEG, header.

Next, in step S8, the extracted metadata is rasterized on the location determined by the printing preferences. Then, in step S9, the remainder of the print job is rasterized and then printed.

Returning to step S5, if there is no metadata present in the print job, the flow proceeds directly to step S9 and the print job is rasterized. Returning to step S6, if it is determined that the existing metadata is not to be printed, flow proceeds directly to step S9, where the print job is rasterized.

It is to be understood that the above described features can be achieved by a method in which a storage medium is supplied to a system or device, the storage medium having computer-executable process steps for realizing the above described functions, and a computer (CPU or MPU) for the system or device that reads the computer-executable process steps stored in the storage medium and executes them.

In this case, the computer-executable process steps read from the storage medium executes the functions of the above described embodiments. Thus, the computer-executable process steps or the storage medium storing the computer-executable process steps therein constitute the present invention.

As a storage medium for supplying the computer-executable process steps, for example, a floppy disk, a hard disk, an optical disk, a magneto-optical disk, a CD-ROM, a CD-R, a magnetic tape, a non-volatile memory card, a ROM, any other applicable computer-readable storage medium can be employed.

When the computer-executable process steps read by the computer are executed, not only are the above described functions of the embodiments realized, but also an operating system working on the computer may carry out part or all of the actual processing that realizes the functions of the above described embodiments.

The computer-executable process steps read from the computer-readable storage medium may be written to a memory provided on a function-extension board inserted into the computer, of a function-extension unit connected to the computer, and a CPU provided on the function-extension board or unit carries out part of all of the actual processing that realizes the functions of the above described embodiments.

While the invention is described above with respect to what is currently its exemplary embodiment, it is to be understood that the invention is not limited to that described above. To the contrary, the invention is intended to cover various modifications and equivalent arrangements within the spirit and scope of the appended claims.

What is claimed is:

1. A method for printing, the method comprising:
selecting data to be printed, wherein the data includes image data;
setting printing preferences associated with a print job to print the data;
submitting the print job;
receiving the print job;
detecting whether metadata associated with the data to be printed exists in the print job;
determining whether any detected metadata is to be printed along with the data to be printed;
creating rasterized data to be printed, wherein the rasterized data includes the data to be printed and metadata determined to be printed; and
printing the rasterized data.

2. The method according to claim 1, wherein setting the printing preferences includes setting whether any metadata is to be printed along with the data to be printed.

3. The method according to claim 2, wherein determining whether any metadata is to be printed includes checking the printing preferences to determine whether any metadata was set to be printed.

4. The method according to claim 2, wherein setting the printing preferences further includes setting a location where the metadata to be printed is located with respect to the data to be printed when the data to be printed and the metadata to be printed are printed.

5. The method according to claim 4, wherein creating the file to be printed includes rasterizing the metadata determined to be printed on the location set in the printing preferences.

6. The method according to claim 1, wherein detecting whether the metadata exists in the print job includes determining if image data exists in the print job, and if image data exists, analyzing a header of the image data for metadata.

7. The according to claim 6, wherein if it is determined that metadata is to be printed, extracting the metadata from the image header.

8. A computer-readable storage medium storing computer-executable process steps for causing a computer to execute the method of claim 1.

9. A print driver comprising:
receiving a print job;
detecting whether metadata associated with the data to be printed exists in the print job;
determining whether any detected metadata is to be printed along with the data to be printed; and
creating rasterized data to be printed, wherein the rasterized data includes the data to be printed and metadata determined to be printed.
